(19) United States
(12) Patent Application Publication
(10) Pub. No.: US 2026/0366888 A1
(43) Pub. Date: Nov. 19, 2026

(54) COMPUTER-IMPLEMENTED METHOD FOR GENERATING A ROAD MAP DATASET

(71) Applicant: Robert Bosch GmbH, Stuttgart (DE)

(72) Inventors: Daniel Kenta Jenet, Stuttgart (DE); Felix Huttner, Ditzingen (DE); Hans-Georg Raumer, Hildesheim (DE); Max Kirstein, Hohenhameln - Ot Bruendeln (DE); Peter Hurt, Filderstadt (DE); Sascha Braun, Reutlingen (DE); Thomas Wenzel, Hamburg (DE); Thorben Funke, Sarstedt (DE)

(21) Appl. No.: 19/660,986

(22) Filed: Apr. 28, 2026

(30) Foreign Application Priority Data
May 14, 2025 (DE) 10 2025 118 556.5

(51) Int. Cl. G01C 21/00; G06N 3/08

(52) U.S. Cl. CPC G01C 21/3859; G01C 21/3815; G06N 3/08

(57) ABSTRACT

A computer-implemented method for generating a road map dataset. The method includes: providing a base road map dataset comprising at least one road map section and supplementing the base road map dataset with at least one new road map section generated from the at least one road map section to form the road map dataset, wherein generating the at least one new road map section comprises a coordinate transformation of the at least one road map section.

### FIELD

The present disclosure relates to a computer-implemented method for generating a road map dataset.

The present disclosure relates in particular to a method for generating a map-like representation (similar to an HD map) of a current environment of a vehicle on the basis of sensor signals, such as camera, radar or lidar signals, by means of a neural network of a vehicle road map generation device. This is generally also referred to as onboard map generation (OMG), i.e., the generation of maps on board a vehicle.

Depending on the configuration, the generated map contains different information, such as lane markings, center lines, road signs or topological relationships, such as an assignment of traffic lights to lanes.

### BACKGROUND INFORMATION

The generation of maps of an environment of a vehicle is generally carried out with the aid of one or more neural networks that predict an environment map from sensor signals. The prediction accuracy of the one or more neural networks depends substantially on differences between training data and application data. These data characteristic differences are generally referred to as a “domain gap.” The more significant the differences between training data and application data are, the more the prediction accuracy of a neural network can be impaired. This may be the case, for example, if the training data originate from a geographical region with left-hand traffic and the neural network is intended to generate environment maps in geographical regions with right-hand traffic.

Exemplary approaches for OMG are described, for example, in: B. Liao et al., “MapTR: Structured Modeling and Learning for online HD Map Construction,” arXiv:2208.14437v2, K. Z. Luo et al., “Augmenting Lane Perception and Topology Understanding with Standard Definition Navigation Maps,” arXiv:2311.04079v1, and T. Li et al., “LaneSegNet: Map Learning with lane segment perception for autonomous driving,” arXiv:2312.16108v2.

### SUMMARY

An object of the present disclosure is to provide a concept with which the previously discussed data characteristic differences can be reduced.

This object may be achieved in a first aspect by a computer-implemented method for generating a road map dataset. According to an example embodiment, the method comprises:
providing a base road map dataset comprising at least one road map section; and
supplementing the base road map dataset with at least one new road map section generated from the at least one road map section to form the road map dataset, wherein generating the at least one new road map section comprises (contains) a coordinate transformation of the at least one road map section.

With the present method, available road map data can be modified by a transformation in such a way that they are equivalent to road map data that would otherwise have to be detected in other geographical regions. These road map data generated by transformation of existing road map data are added to the existing road map data, as a result of which an existing dataset is expanded. As a result, the domain gap can be reduced or closed, as a result of which the performance, in particular the prediction accuracy, of a neural network trained with such an augmented dataset can be improved compared with a neural network that is trained, for example, only on the basis of the base road map dataset.

The method according to the present disclosure can be carried out, for example, during the runtime of the training of a neural network, so that the base map dataset that is thus expanded can be used during the runtime of the training. In other words, the base road map data can be modified during the runtime of the training and can then be used for the training in this modified form.

The base road map dataset can comprise a plurality of road map sections. A plurality of the road map sections or all road map sections can be transferred/transformed into a corresponding new road map section by a coordinate transformation. As a result, an overall highly extensive dataset can be generated, in which the number of road map sections is expanded compared with the base road map dataset.

The coordinate transformation can comprise a reflection about a reflection axis defined in the at least one road map section. Such a coordinate transformation can be performed in a simple manner. Furthermore, road map sections for mirrored traffic routing (i.e., left-hand traffic instead of right-hand traffic and vice versa) can be generated as a result.

The base road map dataset can comprise, in association with the at least one road map section, information regarding a vehicle position and a vehicle driving direction of a vehicle that is located in a geographical area (e.g., on a road) represented/contained in the road map section, wherein the coordinate transformation can be performed based on a Cartesian coordinate system that comprises the vehicle position as an origin and the vehicle driving direction as an x-axis. As a result, a coordinate transformation can be performed from the viewpoint of the vehicle, as a result of which a targeted expansion of the base road map dataset can be provided.

If road map sections corresponding to a geographical region with right-hand traffic are to be generated from road map sections in a geographical region with left-hand traffic, or vice versa, the vehicle driving direction, which can be specified as the x-axis of the underlying coordinate system, can be specified as the reflection axis. As a result of a reflection about the thus defined x-axis, the y-coordinates of the y-axis orthogonal to the x-axis are multiplied by −1.

Here, at least one road map attribute comprising a left-side configuration and a right-side configuration relative to the vehicle driving direction can be modified in such a way that the left-side configuration and the right-side configuration are interchanged. Such traffic attributes can be, for example, turning lanes configured as left-turn lanes or right-turn lanes, or turning information at traffic lights configured as left-turn arrows or right-turn arrows. Furthermore, a left roadway boundary and a right roadway boundary can be interchanged.

The at least one road map section can be an image detected by a sensor device or an a priori road map. The base road map dataset can comprise at least one road map section that is an image detected by a sensor device and at least one road map section that is an a priori road map. The sensor device can comprise, for example, one or more of a video sensor, radar sensor, lidar sensor, ultrasonic sensor or IR sensor, or can be configured as one or more of these sensors. An a priori road map, also referred to as a map prior or SD (standard definition) map, is a low-quality road map that substantially comprises only information regarding a road topology.

In a second aspect of the present disclosure, a data processing device is provided that is configured to perform an above-described method. According to an example embodiment, the data processing device can comprise, for example, a processor or a microprocessor or an application-specific integrated circuit (ASIC), etc., or can be configured as such.

In a third aspect of the present disclosure, a computer program is provided with instructions that, when executed by a processor, cause the processor to perform an above-described method of the present disclosure.

In a fourth aspect of the present disclosure, a computer-readable medium is provided that stores instructions that, when executed by a processor, cause the processor to perform an above-described method of the present disclosure. The computer-readable medium can comprise, for example, a read-only memory (ROM), a random-access memory (RAM), etc., or can be configured as such.

In a fifth aspect of the present disclosure, a method for training a neural network of a vehicle road map generation device is provided, wherein the neural network is trained on the basis of a road map dataset generated according to an above-described method of the present disclosure as a training dataset.

In a sixth aspect of the present disclosure, a vehicle is provided. According to an example embodiment, the vehicle comprises: a vehicle road map generation device implementing a neural network and at least one sensor device configured to capture an image of an environment of the vehicle and output image signals corresponding to the image, wherein the vehicle road map generation device is configured to predict a map of the environment of the vehicle from the image signals by means of the neural network, wherein the neural network is trained by means of an above-described method of the present disclosure for training a neural network.

The present disclosure is described in detail below by reference to the figures.

### BRIEF DESCRIPTION OF THE DRAWINGS

FIG. 1 is a schematic representation of a vehicle road map generation device according to the present disclosure.

FIG. 2 is a flowchart of an exemplary computer-implemented method for generating a road map dataset.

FIGS. 3A and 3B illustrate an exemplary coordinate transformation that can be performed within the framework of a method for generating a road map dataset according to an example embodiment of the present disclosure.

FIG. 4 is a schematic representation of a vehicle according to an example embodiment of the present disclosure.

### DETAILED DESCRIPTION OF EXAMPLE EMBODIMENTS

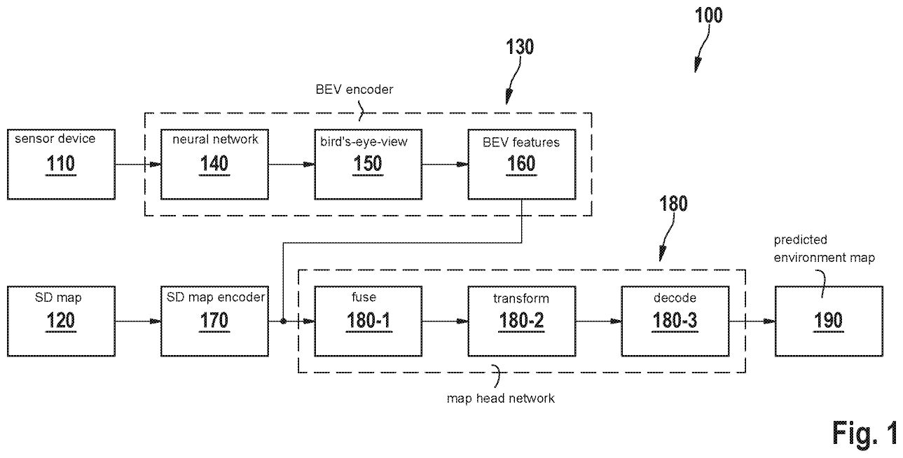

FIG. 1 is a schematic representation of a vehicle road map generation device 100 configured to predict a map of an environment of the vehicle on the basis of environment images captured by a sensor device 110 provided on a vehicle and on the basis of a priori road maps 120. The vehicle road map generation device 100 can implement one or more neural networks.

The sensor device 110 can be configured, for example, as a video sensor, radar sensor, lidar sensor, ultrasonic sensor or IR sensor, or can comprise one or more of these sensors. An a priori road map (also referred to as an SD (standard definition) map or map prior) is a low-quality road map comprising information regarding a road topology.

The images output by the sensor device 110 are supplied to a BEV (bird's-eye view) encoder 130, which transforms them into a bird's-eye view 150 by means of a neural network 140, which is also referred to herein as a backbone network, and extracts BEV features 160 in this view.

The SD map 120 is encoded by means of an SD map encoder 170 and subsequently supplied to a map head network 180, in which the encoded SD map is fused with the extracted BEV features 160 (at 180-1). The fused data are subsequently transformed (at 180-2), decoded (at 180-3) and subsequently output as a predicted environment map 190.

The architecture outlined in FIG. 1 is generally referred to as an OMG network. Further details regarding OMG networks can be found, for example, in T. Li et al., “LaneSegNet: Map Learning with lane segment perception for autonomous driving,” arXiv:2312.16108v2, or H. Wu et al., “BLOS-BEV: Navigation Map Enhanced Lane Segmentation Network, Beyond Line of Sight,” arXiv:2407.08526v1.

The map data can be composed of polylines (e.g., lane markings), polygons (e.g., pedestrian crossings), individual points (e.g., traffic signs) and relationships therebetween. Polylines can be represented by a list of 2-dimensional or 3-dimensional coordinates.

A Cartesian coordinate system can be used as the coordinate system, the origin of which is specified by the vehicle position. The x-axis of the coordinate system can be selected as the vehicle driving direction. Thus, the y-axis is a direction orthogonal to the vehicle driving direction. An optional z-coordinate describes a height direction.

All geometric objects (polylines, polygons, points) can have additional attributes (e.g., line type). Polylines can be combined into lane segments. Lane segments are composed of exactly three polylines (left boundary, center line, right boundary). Here, the terms left/right are to be understood in the driving direction.

The prediction accuracy of the vehicle road map generation device 100 depends substantially on differences between training data and application data. These data characteristic differences are generally referred to as a “domain gap.” The more significant the differences between training data and application data are, the more the prediction accuracy of the vehicle road map generation device 100 can be impaired. This can be the case, for example, if the training data originate from a geographical region with left-hand traffic and the vehicle road map generation device 100 is intended to generate environment maps in geographical regions with right-hand traffic.

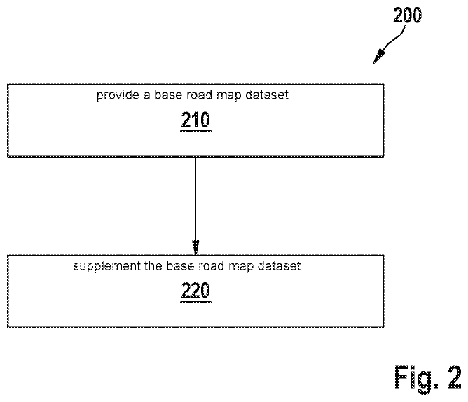

These data characteristic differences can be reduced by means of a computer-implemented method 200 for generating a road map dataset. A flowchart of such a method 200 according to the present disclosure is shown in FIG. 2.

As shown in FIG. 2, the method 200 can comprise:
providing 210 a base road map dataset comprising at least one road map section; and
supplementing 220 the base road map dataset with at least one new road map section generated from the at least one road map section to form the road map dataset, wherein generating the at least one new road map section comprises a coordinate transformation of the at least one road map section.

With the method 200, available road map data can be modified by a transformation in such a way that they are equivalent to road map data that would otherwise have to be detected in other geographical regions. The newly generated road map data are added to the base map dataset. As a result, the domain gap can be reduced or closed, as a result of which the performance, in particular the prediction accuracy, of a neural network trained with such an augmented dataset can be improved compared with a neural network that is trained, for example, only on the basis of the base road map dataset.

The base road map dataset can comprise a plurality of road map sections. A plurality of the road map sections or all road map sections can be transferred into a corresponding new road map section by a coordinate transformation. As a result, an overall highly extensive dataset can be generated, in which the number of road map sections is increased compared with the base road map dataset.

The coordinate transformation can comprise a reflection about a reflection axis defined in the at least one road map section. Such a coordinate transformation can be performed in a simple manner. Furthermore, road map sections for mirrored traffic routing can be generated as a result.

The base road map dataset can comprise, in association with the at least one road map section, information regarding a vehicle position and a vehicle driving direction of a vehicle that is located in a geographical region (e.g., on a road) corresponding to the road map section, wherein the coordinate transformation can be performed based on the above-described Cartesian coordinate system, which comprises the vehicle position as an origin and the vehicle driving direction as an x-axis. As a result, a coordinate transformation can be performed from the viewpoint of the vehicle, as a result of which a targeted expansion of the base road map dataset can be provided.

If road map sections corresponding to a geographical region with right-hand traffic are to be generated from road map sections in a geographical region with left-hand traffic, or vice versa, the vehicle driving direction, which can be specified as the x-axis, can be specified as the reflection axis. As a result of a reflection about the thus defined x-axis, the y-coordinates of the y-axis orthogonal to the x-axis are multiplied by −1.

Here, at least one road map attribute comprising a left-side configuration and a right-side configuration relative to the vehicle driving direction x can be modified in such a way that the left-side configuration and the right-side configuration are interchanged. Such traffic attributes can be, for example, turning lanes configured as left-turn lanes or right-turn lanes, or turning information at traffic lights configured as left-turn arrows or right-turn arrows. Furthermore, a left roadway boundary and a right roadway boundary can be interchanged.

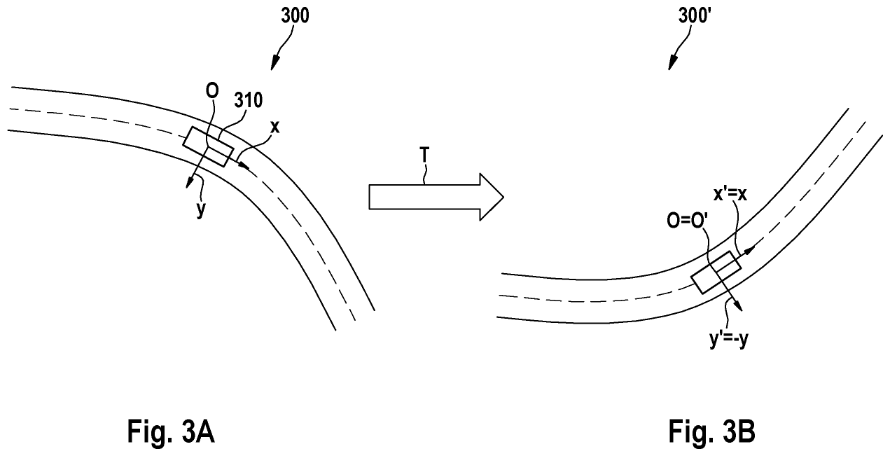

A coordinate transformation based on reflection about an x-axis in a Cartesian coordinate system, wherein the x-axis corresponds to the vehicle driving direction, is schematically illustrated in FIGS. 3A and 3B.

FIG. 3A shows the driving situation in a road map section 300 of the base road map dataset. Such a road map section 300 can be, for example, a section of an SD map or an HD map captured by a sensor. The road map section 300 contains information regarding the vehicle 310, in particular a vehicle position O and a vehicle direction x. The vehicle position O defines the origin of a Cartesian coordinate system with an x-axis and a y-axis orthogonal thereto.

FIG. 3B shows a new road map section 300′, which is generated from the road map section 300 by means of a transformation T in which the y-coordinates are multiplied by −1. In the transformed road map section 300′, the vehicle position, i.e., the origin of the coordinate system, is indicated by O′. This remains unchanged under the transformation T. The x-coordinates also remain unchanged, i.e., x′=x.

Furthermore, all map attributes having a left variant and a right variant are interchanged, e.g., a left-turn lane is replaced by a right-turn lane, a left-turn arrow at a traffic light is replaced by a right-turn arrow, a left road boundary is replaced by a right road boundary, etc.

The at least one road map section 300 can be an image detected by a sensor device (also referred to as “ground-truth” data) or an a priori road map (SD map). The base road map dataset can comprise, for example, at least one road map section that is an image detected by a sensor device and at least one road map section that is an a priori road map.

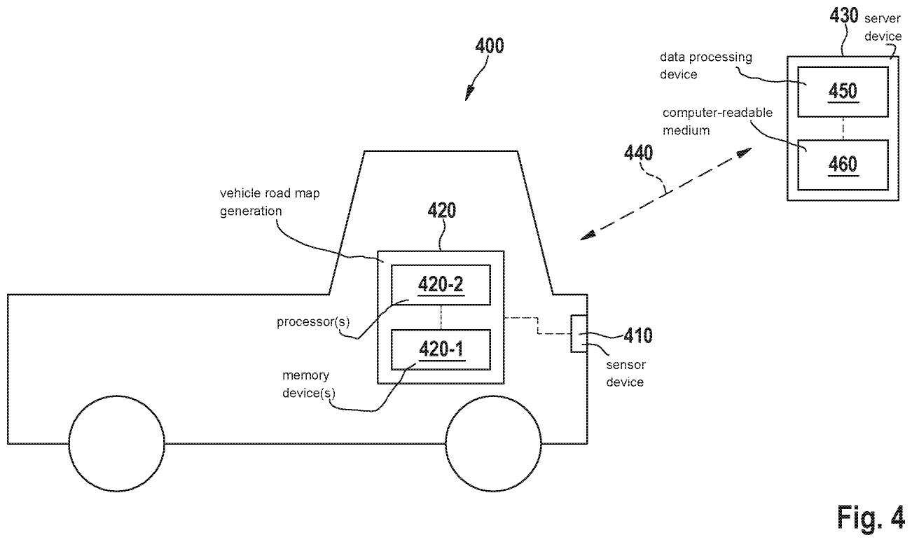

FIG. 4 is a schematic view of a vehicle 400 according to the present disclosure. As shown in FIG. 4, the vehicle 400 can comprise a sensor device 410 and a vehicle road map generation device 420. The sensor device 410 is configured to capture an image of an environment of the vehicle 400. The sensor device 410 can comprise, for example, one or more of a video sensor, radar sensor, lidar sensor, ultrasonic sensor or infrared sensor, or can be configured as such.

The sensor device 410 can be configured to output image signals corresponding to a captured image to the vehicle road map generation device 420. The vehicle road map generation device 420 can be configured, for example, like the vehicle road map generation device 100 shown in FIG. 1.

The vehicle road map generation device 420 can comprise at least one memory device 420-1 and at least one processor 420-2. The memory device 420-1 can be configured to store program code executable by the processor 420-2. By executing the program code stored in the memory device 420-1, for example, the OMG network described based on FIG. 1 can be implemented. The memory device 420-1 can comprise, for example, a read-only memory (ROM), a random access memory (RAM), etc., or can be configured as such. The vehicle road map generation device 420 is thus configured to estimate, i.e., generate, an HD map of the vehicle environment on the basis of the received image signals, optionally on the basis of the image signals and SD map information.

The one or more neural networks of the vehicle road map generation device 420 can be trained on the basis of a road map dataset generated by means of an above-described method.

The program code with which the one or more neural networks, e.g., the OMG network according to FIG. 1, can be implemented can be transmitted, for example, from an external server device 430 to the vehicle road map generation device 420, for example via a wireless network 440.

The server device 430 can comprise, for example, a data processing device 450 configured to perform an above-described method 200 for generating a road map dataset. The data processing device 450 can comprise, for example, a processor or a microprocessor or an application-specific integrated circuit (ASIC), etc., or can be configured as such. The server device 430 can further comprise a computer-readable medium 460 storing instructions, such as program code, that, when executed by the data processing device 450, cause the data processing device 450 to perform the above-described method 200 for generating a road map dataset.

1-11. (canceled)

12. A computer-implemented method for generating a road map dataset, the method comprising the following steps:
providing a base road map dataset including at least one road map section; and
supplementing the base road map dataset with at least one new road map section generated from the at least one road map section to form the road map dataset, wherein the generating of the at least one new road map section includes a coordinate transformation of the at least one road map section.

13. The method according to claim 12, wherein the coordinate transformation includes a reflection about a reflection axis defined in the at least one road map section.

14. The method according to claim 13, wherein the base road map dataset includes, in association with the at least one road map section, information regarding a vehicle position of a vehicle and a vehicle driving direction of the vehicle located in a geographical region represented in the at least one road map section, wherein the coordinate transformation is performed based on a Cartesian coordinate system including the vehicle position as an origin.

15. The method according to claim 14, wherein the reflection axis is identical to the vehicle driving direction.

16. The method according to claim 15, wherein the generating of the at least one new road map section further includes: modifying at least one road map attribute including a left-side configuration and a right-side configuration relative to the vehicle driving direction in such a way that the left-side configuration and the right-side configuration are interchanged.

17. The method according to claim 12, wherein the at least one road map section is an image detected by a sensor device or the at least one road map section is an a priori road map.

18. A data processing device configured to perform a method for generating a road map dataset, the method comprising the following steps:
providing a base road map dataset including at least one road map section; and
supplementing the base road map dataset with at least one new road map section generated from the at least one road map section to form the road map dataset, wherein the generating of the at least one new road map section includes a coordinate transformation of the at least one road map section.

19. A non-transitory computer-readable medium on which are stored instructions for generating a road map dataset, the instructions, when executed by a processor, causing the processor to perform the following steps:
providing a base road map dataset including at least one road map section; and
supplementing the base road map dataset with at least one new road map section generated from the at least one road map section to form the road map dataset, wherein the generating of the at least one new road map section includes a coordinate transformation of the at least one road map section.

20. A method for training a neural network of a vehicle road map generation device, the method comprising:
generating a road map dataset, including:
providing a base road map dataset including at least one road map section, and
supplementing the base road map dataset with at least one new road map section generated from the at least one road map section to form the road map dataset, wherein the generating of the at least one new road map section includes a coordinate transformation of the at least one road map section; and
training the neural network based on the generated road map dataset.

21. A vehicle, comprising:
a vehicle road map generation device implementing a neural network and at least one sensor device configured to capture an image of an environment of the vehicle and output image signals corresponding to the image, wherein the vehicle road map generation device is configured to predict a map of the environment of the vehicle from the image signals using the neural network, wherein the neural network is trained by:
generating a road map dataset, including:
providing a base road map dataset including at least one road map section, and
supplementing the base road map dataset with at least one new road map section generated from the at least one road map section to form the road map dataset, wherein the generating of the at least one new road map section includes a coordinate transformation of the at least one road map section; and
training the neural network based on the generated road map dataset.
